(19) United States
(12) Patent Application Publication
(10) Pub. No.: US 2016/0353799 A1
(43) Pub. Date: Dec. 8, 2016

(54) Non-porous Atomizer Chamber

(71) Applicant: GREGORY OTTO, POMPANO BEACH, FL (US)

(72) Inventor: GREGORY OTTO, POMPANO BEACH, FL (US)

(21) Appl. No.: 14/731,407

(22) Filed: Jun. 5, 2015

(51) Int. Cl. A24F 47/00; H05B 3/00

(52) U.S. Cl. CPC A24F 47/008; H05B 3/0014

(57) ABSTRACT

A nonporous atomizer chamber atomizes a tobacco substance and is operable with a vaporizer. The chamber is fabricated from a nonporous material composition that is generally not permeable to water, gas, or other fluids. The nonporous material is effective for use with the chamber, where high temperatures create chemical reactions with the tobacco substance that cause absorption into the pores of a housing of the chamber. This creates undesirable toxic cumulates that leave aftertaste, off gas, and discolor in the housing. The housing atomizes the tobacco substance with a uniquely disposed heating coil. The heating coil takes three different possible positions, with each position creating a synergy with the nonporous material of the chamber to provide optimal atomization. A flat, coplanar position with a closed end of the housing prevents blockage of holes. A transverse disposition heats up efficiently. A longitudinal disposition occupies large volume area in the housing.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to nonporous atomizer chamber for use with a vaporizer to optimize atomization of a tobacco substance.

It is known that an electronic cigarette is a typically a plastic stick that uses a nicotine filter cartridge to simulate the traditional smoking experience. Unlike the traditional smoking experience, however, there is no smoke or tar. A battery-powered electronic cigarette produces a similar feel to tobacco smoking. Electronic cigarettes produce an aerosol, commonly called vapor, rather than cigarette smoke, which the user inhales.

The inventor has smoked numerous types of electronic cigarette, e-pipes, and vaporizers known in the art. The inventor is also experienced in the manufacture of electronic cigarettes. Thus, the inventor was aware that most electronic cigarettes have the shape of a regular cigarette and provide the user with either a mixture of tobacco aromas, tobacco substitutes, or nicotine/nicotine substitutes as replacements for an all tobacco cigarette.

While smoking an e-cigarette, the inventor recognized a problem with the taste and flavor. The inventor noticed an aftertaste from prior tobacco substances that were smoked in the electronic cigarette. The inventor also noted a faint off gas that emitted from the e-cigarette while smoking The off gas had a slightly different smell than the tobacco substance being smoked. The aftertaste and the off gas resembles prior tobacco substances from earlier smokes by the inventor. Initially, the inventor did not see anything in the e-cigarette that might lead to this aftertaste.

The inventor decided to disassemble the e-cigarette to investigate further. From past experiences, the inventor knew that the atomizer component of the e-cigarette was where the substantial part of the burning occurred. Thus, this seemed like the most likely component of the e-cigarette where the aftertaste may originate from. The inventor's first clue was a slight discoloration along the inner wall of the atomizer.

Through additional research, the inventor learned that high temperatures, as occurs in the atomizer, a chemical reaction occurs with the tobacco substance. The chemical reaction results in a toxic cumulate consisting of tar, waxy tobacco extract, heavy metals, and carcinogens.

Through research, the inventor learned that the toxic cumulates were susceptible to being absorbed in a porous material. The inventor saw that the atomizer in the electronic cigarette was fabricated from ceramic, which is porous. Thus, the inventor surmised that the ceramic atomizer had absorbed sufficient quantities of toxic cumulates from prior smoked tobacco substances. This was what created the aftertaste and the off smoke.

The inventor researched possible other materials to use in the atomizer that would not be absorbed, or accumulate on the surface of the atomizer chamber, but could still withstand temperatures in excess of 300° Fahrenheit. The inventor's research concluded that nonporous materials that could withstand high temperatures included quartz and glass.

Consequently, the inventor manufactured an atomizer from quartz glass. Shortly thereafter, the inventor noticed a considerable drop in aftertaste and off gas, since the cumulative smokes were not leaving behind toxic cumulates in the pores of the quartz glass. The atomizer chamber was also easier to clean and produced a flavor that was more consistent with the tobacco substance being smoked at the time.

However, the inventor wondered if it would be possible to further optimize the atomization of the tobacco substance, such that even less of the toxic cumulate was available to be absorbed or accumulated on the surface of the atomizer chamber. The inventor knew that the heating coil inside the atomizer chamber emitted the thermal energy used to atomize the tobacco substance. The inventor recognized that increasing the heat would not necessarily optimize the burn. The inventor wondered if manipulating the heating coil would make a difference.

The inventor decided to manipulate the heating coil in different positions. Through trial and error, the inventor recognized that each new positon of the heating coil provided an advantage that optimized the atomization, but in a different manner. For example, when the inventor placed the heating coil flat and against a closed end of the atomizer chamber, very little tobacco substance was wasted. When the inventor positioned the heating coil transversely across the length of the atomizer chamber, the condensed length quickly heated up the heating coil.

When the inventor positioned the heating coil along the length of the atomizer chamber, a substantial amount of the volume area in the atomizer chamber was covered. In all cases though, the atomization was further optimized. Thus the inventor recognized that changing the material composition of the atomizer to a nonporous material, and manipulating the position of the heating coil created a synergy that eliminated aftertaste, off gas, and even discoloration in the atomizer chamber. The inventor finally learned that coating a heat displacement coating on the atomizer chamber further optimized the atomization, since the porosity of the atomizer chamber was even further reduced.

For the foregoing reasons, there is a nonporous atomizer chamber that uses a nonporous material and manipulates a heating coil to create an optimal atomization of a tobacco substrate.

E-cigarette atomizers have been utilized in the past; yet none with the present delivery expediting characteristics of the present invention. See U.S. Pat. Nos. 8,365,742; 8,375,957; and 8,757,169.

For the foregoing reasons, there is a nonporous atomizer chamber with a housing fabricated from a nonporous material that does not absorb or allow accumulation of toxic cumulates, and also enables manipulation of a heating coil to create optimal atomization of a tobacco substrate.

### SUMMARY

The present invention describes a nonporous atomizer chamber, of the type used in vaporizers, e-cigarettes, and e-pipes, in general. The nonporous atomizer chamber, hereafter, “chamber”, is fabricated from a nonporous material composition that efficiently atomizes the tobacco substance while not absorbing or accumulating toxic cumulate on its surface. The chamber is also configured to further optimize the atomization of the tobacco substance by selectively manipulating a heating coil in multiple positions. Each positon of the heating coil is adaptable to optimize the atomization in the chamber in a different manner. Consequently, the chamber produces an optimal burn of a tobacco substance to achieve a desired vapor effect and flavor, without causing the undesirable aftertaste, off gas, discoloration, and toxic residual coating that occurs in porous materials, such as steel and ceramics.

The chamber provides an optimal burn by atomizing the tobacco substance in a nonporous material composition and at a controlled temperature by the heating coil. The nonporous material is effective for inhibiting a tobacco substance from adhering to the inner sidewall of the chamber. The nonporous material may include, without limitation, quartz, fused quarts, quartz-glass, and glass. The tobacco substance may include, without limitation, tobacco leaves, waxy tobacco extracts, medicinal cannabis extracts, and e-liquids.

Furthermore, a uniquely disposed heating coil inside the chamber helps reduce loss and inefficient burning of tobacco substance inside the chamber. In one embodiment, the heating coil is disposed coplanar with a closed end of the chamber. This orientation restricts the tobacco substance from passing through holes in the closed end. In another embodiment, the heating coil is disposed transversely across the length of the heating coil. This transverse position inside the chamber is condensed, and thus heats up the heating coil rapidly. A final disposition includes the heating coil extended along the longitudinal axis of the chamber. This orientation covers the most volume area inside of the chamber, consequently creating an efficient atomization of the tobacco substance.

In some embodiments, the chamber includes a generally cylindrically shaped housing. The housing is defined by a generally cylindrical sidewall, an open end, and a closed end. The housing is fabricated from a nonporous material, such as quartz or glass. The housing reaches high temperatures during atomization. This creates chemical reactions with the tobacco substance that often produce undesirable toxic cumulates, which are absorbed by porous materials. Thus, the nonporous material inhibits accumulation and absorption of tobacco substance residues, such as carcinogens, heavy metals, and tar, into the sidewall of the housing.

The closed end of the housing comprises a center hole and a pair of free ends. The center hole is configured to enable the passage of outside air into the housing. This may be possible when a user sucks on a mouthpiece of the vaporizer, creating a temporary vacuum in the housing that draws in the outside air. The pair of outer holes are configured to enable engagement between a battery in the vaporizer and a heating coil that sits inside the housing.

In some embodiments, the heating coil is defined by a coil body and a pair of free ends. The coil is configured to generate thermal energy that is sufficient to atomize the tobacco substance. The coil body may be disposed in multiple dispositions that are effective for optimizing the atomization, and thus creates a synergy with the nonporous material of the housing to prevent toxic accumulates from forming on the sidewalls and closed end of the housing.

The coil body emit thermal energy that is sufficient to atomize the tobacco substance in the housing. In one embodiment, the heating coil positions in a generally coplanar orientation in relation to the closed end of the housing. This flat position forms a barrier that restricts tobacco substance particulates from blocking the central hole or the pair of outer holes in the closed end of the housing. The coil body can also be disposed to prevent blockage of the central hole and the pair of outer holes in the closed end of the housing. The pair of free ends are arranged to pass through the pair of outer holes of the closed end of the housing for accessing a battery.

In one embodiment, the heating coil positions in a generally transverse orientation in relation to the length of the housing. This transverse position inside the housing is condensed, and thus heats up the heating coil rapidly. In another embodiment, the coil body extends along the longitudinal axis of the housing. This orientation covers the most volume area inside of the housing, consequently creating an efficient atomization of the tobacco substance.

The pair of free ends pass through the pair of outer holes in the closed end of the housing. The pair of free ends engage a battery and create a voltage therebetween. In one embodiment, resistive heating occurs as resistance in the heating coil generates the thermal energy for atomization. In any case, the nonporous material and the unique dispositions of the heating coil create an optimal atomization with minimal toxic cumulates that cause off gas, aftertaste, and discoloration of the housing.

One objective of the present invention is to fabricate the housing of the chamber from a nonporous material composition, such as quartz, glass, and quartz glass.

Another objective of the present invention is to position the heating coil in one of three possible orientations inside the housing.

Another objective of the present invention is to optimize the atomization of the tobacco substance by inhibiting absorption into the pores of the housing, by restricting blockage of holes in the housing, by creating an efficient heating, and by maximizing volume area in the housing by the heating coil.

Yet another objective of the present invention is to eliminate aftertaste from toxic cumulates on the sidewalls of the housing.

Yet another objective is to eliminate off gas from toxic cumulates on the sidewalls of the housing.

Yet another objective is to provide a relatively self-cleaning, nonporous housing.

Yet another objective is to provide a flavor that is more consistent with the tobacco substance being smoked at the time.

Yet another objective is to provide a heat displacement coating on the sidewalls of the housing.

### DRAWINGS

These and other features, aspects, and advantages of the present invention will become better understood with regard to the following description, appended claims, and drawings where:

FIG. 1 is a top view of an exemplary vaporizer having a nonporous atomizer chamber;

FIGS. 2A and 2B are sectioned side views of the nonporous atomizer chamber with a heating coil, where FIG. 2A is the heating coil disposed transversely to the housing and elevated from a closed end of the housing, and FIG. 2B is the heating coil in a flat configuration and disposed coplanar to the closed end of the housing;

FIGS. 3A and 3B are views of the nonporous atomizer chamber with the heating coil disposed coplanar to the closed end of the housing, where FIG. 3A is an elevated side view, and FIG. 3B is a top view;

FIGS. 4A and 4B are views of the nonporous atomizer chamber with the heating coil disposed transversely to the housing, where FIG. 4A is an elevated side view, and FIG. 4B is a top view; and

FIGS. 5A and 5B are views of the nonporous atomizer chamber with the heating coil disposed along the length of the housing, where FIG. 5A is an elevated side view, and FIG. 5B is a top view.

### DESCRIPTION

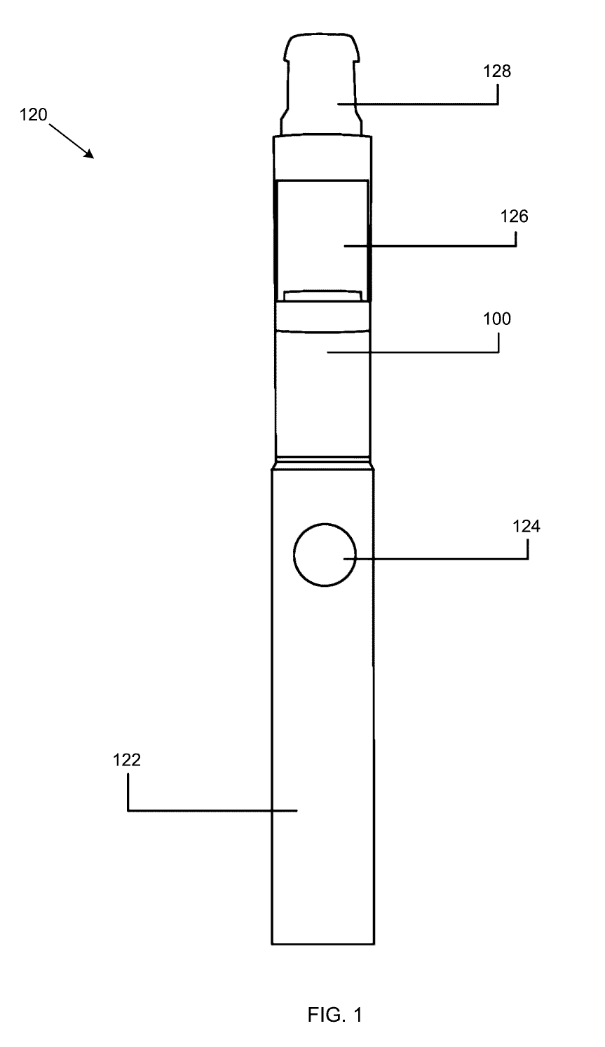

The present invention, referenced in FIGS. 1-5B, is directed to a nonporous atomizer chamber 100, hereafter, “chamber 100” that atomizes a tobacco substance (not shown). The chamber 100 may be operable with a vaporizer 120, such as an e-cigarette, an e-pipe, an ion vaporizer, a portable vaporizer, and an aromatherapy device. The chamber 100 is fabricated substantially from a nonporous material. The nonporous material of the chamber 100 is generally not permeable to water, gas, or other fluids.

The nonporous material is effective for use with the chamber 100, where high temperatures create chemical reactions with the tobacco substance. The chemical reactions produce a toxic cumulate that has a proclivity to absorb into the pores of the chamber 100, or accumulate on the outer surface of the chamber 100; thereby forming an undesirable, discoloration to the chamber 100. This absorption and surface accumulation of toxic cumulates is undesirable in that it leaves an aftertaste of prior tobacco substances, produces an off gas, detracts from the pure flavor of the tobacco substance being smoked at the time, and discolors the chamber.

As illustrated in FIG. 1, the chamber 100 works in conjunction with the vaporizer 120 to atomize the tobacco substance for smoking The vaporizer 120 includes multiple components that work in conjunction with the chamber 100. The components of the vaporizer 120 may include, without limitation, a battery 122, a power switch 124, a tobacco substance chamber 126, a filter, and a mouthpiece 128. In one possible embodiment, the chamber 100 positions, generally between the battery 122 and the tobacco substance chamber 126. The battery 122 provides the heating coil 114 in the chamber 100 with voltage for generating thermal energy in that is sufficient to atomize the tobacco substance. Opposite the battery 12, the tobacco substance chamber 126 holds and periodically releases the tobacco substance into the chamber 100 for atomization.

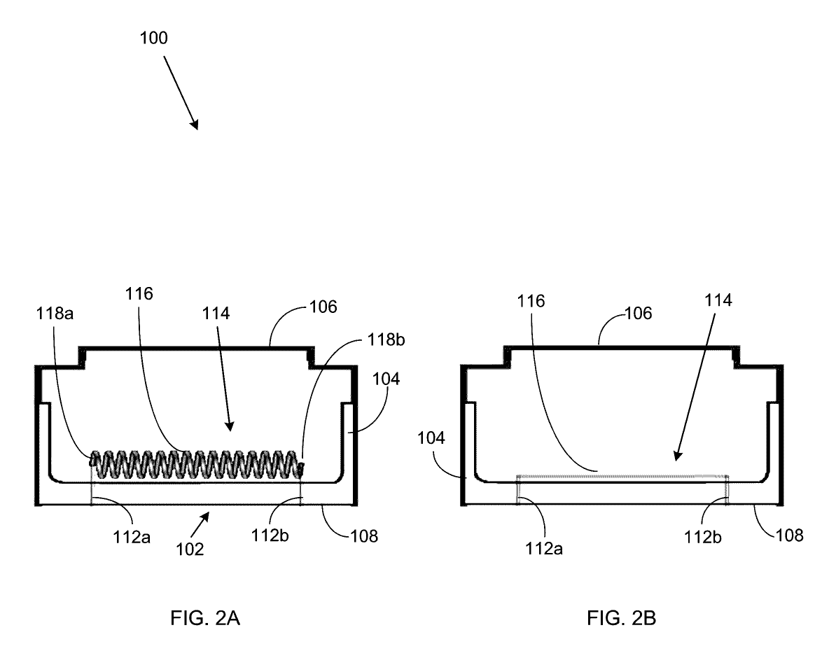

Turning now to FIG. 2A, the chamber 100 comprises a housing 102 and a heating coil 114 that is manipulated into different positions inside the housing 102. Thus, the atomization of the tobacco substance occurs predominantly in the housing 102. The housing 102 is defined by a generally cylindrical sidewall 104, an open end 106, and a closed end 108. The closed end includes a center hole 110 and a pair of outer holes 112a, 112b. The housing 102 is fabricated from a nonporous material, such as quartz or glass.

A uniquely disposed heating coil 114 positions in the housing 102. The heating coil 114 emits thermal energy to atomize the tobacco substance. The heating coil 114 can be placed in at least three different positions in the housing 102, with each position creating a synergy with the nonporous material of the housing 102 to provide optimal atomization of the tobacco substance. In this manner, the chamber 100 produces an optimal burn of a tobacco substance to achieve a desired vapor effect and flavor, without causing the undesirable aftertaste, off gas, discoloration, and toxic residual coating found in porous materials, such as metal and ceramics. FIG. 2B shows one possible disposition of the heating coil 114, where it is configured flat and aligned coplanar to a closed end 108 of the housing 102.

Thus, the chamber 100 provides an optimal burn in two different manners, with each forming a synergy to the other. First, the housing 102 is fabricated from a nonporous material that is used to inhibit absorption of the tobacco substance. The nonporous material is effective for inhibiting a tobacco substance from absorbing into pores, or adhering to the inner sidewall 104 of the housing 102. The nonporous material may include, without limitation, quartz, fused quarts, quartz-glass, and glass. The tobacco substance may include, without limitation, tobacco leaves, waxy tobacco extracts, medicinal cannabis extracts, and e-liquids.

Secondly, the positioning of the heating coil 114 optimizes the atomization of the tobacco substance. The heating coil 114 is uniquely disposed inside the housing 102 to reduce loss of tobacco substance and create an efficient burn inside the chamber 100. In one embodiment, the heating coil 114 is disposed coplanar with a closed end 108 of the housing 102. This orientation restricts the tobacco substance from passing through holes in the closed end 108 of the housing 102.

In another embodiment, the heating coil 114 is disposed transversely across the length of the housing 102. This transverse position inside the chamber 100 is condensed, and thus enables the heating coil 114 to heats up rapidly. A final disposition includes the heating coil 114 extended along the longitudinal axis of the housing 102. This orientation enables the heating coil 114 to cover the most volume area inside of the housing 102, consequently creating an efficient atomization of the tobacco substance.

Looking back at FIG. 2A, the chamber 100 includes a generally cylindrically shaped housing 102. However, in other embodiments, the housing 102 may have other shapes, including a rectangle, a cube, a pyramid, a star shape, a trapezoid, and a rhombus. The housing 102 is defined by a generally cylindrical sidewall 104, an open end 106, and a closed end 108. The housing 102 is fabricated from a nonporous material, such as quartz, glass, and quartz-glass.

The housing 102 reaches high temperatures during atomization. This creates chemical reactions with the tobacco substance that produce undesirable toxic cumulates. These toxic cumulates are absorbed or accumulate on porous materials. Thus, the nonporous material of the present invention inhibits accumulation and absorption of the toxic cumulates from the tobacco substance, such as carcinogens, heavy metals, and tar.

In one embodiment, a heat displacement coating is applied to the sidewall 104 of the housing 102 to further inhibit absorption and accumulation of toxic cumulates. The heat displacement coating, such as Alumina, improves energy efficiency and prevents damage to the underlying nonporous material. However, a nano-coating, which is known in the art, may be used to inhibit absorption and accumulation of toxic cumulates. Additionally, the nonporous material of the housing 102 facilitates cleaning of the housing 102. In one embodiment, the housing 102 is cleaned with isopropyl alcohol. This further eliminates aftertaste, off gas, and detraction from the pure flavor of the tobacco substance.

Those skilled in the art will recognize that the temperatures inside the housing 102 may often exceed 300° Fahrenheit. These high temperatures create chemical reactions and oxidation in a porous material. This results in the integration of toxic tobacco extracts, tar, carcinogens, char, heavy metals, and waxy tobacco extracts into the sidewall 104 of the housing 102. It is also significant to note that tobacco plants may absorb and accumulate heavy metals, such as copper, iron, chromium, lead, and uranium. Under high temperatures, such as atomization, these heavy metals are absorbed in porous materials. Long-term exposure to these heavy metals can increase a smokers' risk of head and neck cancers, as well as other diseases.

Additionally, the metal used in prior art atomizer chambers is often fabricated and extruded through the assembly line with the use of oils. These oils remain embedded in the metal, even after the metal has been formed into a metal atomizer chamber. The oils form an off gas and other undesirable atomization effects. Conversely, the nonporous material of the housing, which is not produced with metals having oils, but rather, quartz and glass, prevents the absorption and accumulation of the toxic cumulates by inhibiting undesirable burning of oils and absorption of toxic accumulates into pores.

In some embodiments, the closed end 108 of the housing 102 comprises a center hole 110 and a pair of free ends 118a, 118b. The center hole 110 is configured to enable the passage of outside air into the chamber 100. This occurs chiefly, when a user sucks on a mouthpiece 128 of the vaporizer 120, creating a temporary vacuum in the chamber 100 that draws in the outside air.

The pair of outer holes 112a, 112b in the closed end 108 of the housing 102 are configured to enable passage of the free ends 118a, 118b of the heating coil 114 to engage the battery 122 in the vaporizer 120. The open end 106 of the housing 102 receives the tobacco substance for atomizing. The open end 106 may couple to the tobacco substance chamber 126 through threaded openings, frictional engagement, or magnetic coupling.

In some embodiments, the heating coil 114 is defined by a coil body 116 and a pair of free ends 118a, 118b. The coil body 116 forms a generally spiral shape. The coil body 116 is configured to generate thermal energy in the chamber 100 that is sufficient to atomize the tobacco substance. The coil body 116 may be disposed in multiple dispositions that are effective for optimizing the atomization. Whereby a synergy is created with the nonporous material in the chamber 100 to prevent toxic accumulates from forming on the sidewall 104 and closed end 108 of the housing 102. The coil body 116 of the heating coil 114 is configured to emit thermal energy for atomization. The thermal energy is sufficient to atomize the tobacco substance in the housing 102.

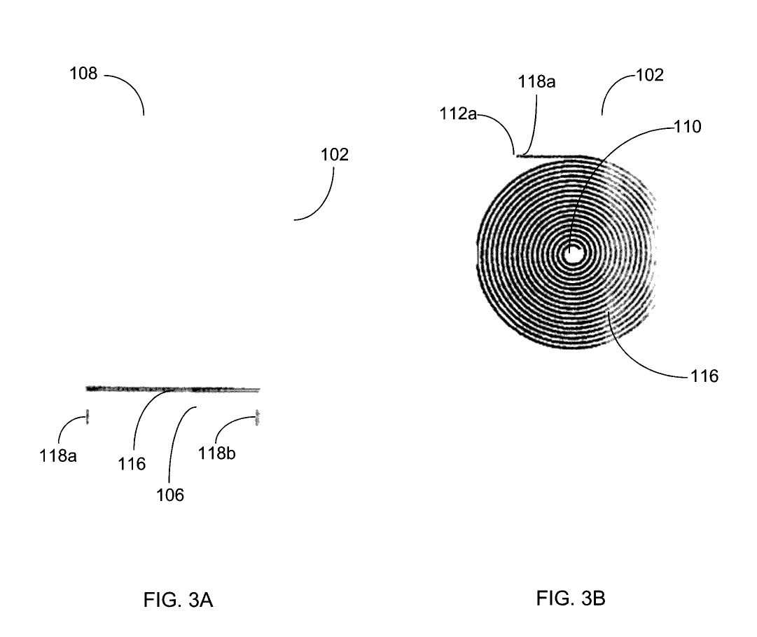

In one embodiment, referenced in FIGS. 3A and 3B, the heating coil 114 positions in a generally coplanar orientation in relation to the closed end 108 of the housing 102. This flat position forms a barrier that restricts tobacco substance particulates from blocking the central hole or the pair of outer holes 112a, 112b in the closed end 108 of the housing 102. The coil body 116 is also configured to substantially restrict passage through the central hole and the pair of outer holes 112a, 112b in the closed end 108 of the housing 102. The pair of free ends 118a, 118b are arranged to pass through the pair of outer holes 112a, 112b of the closed end 108 of the housing 102 to engage the battery 122.

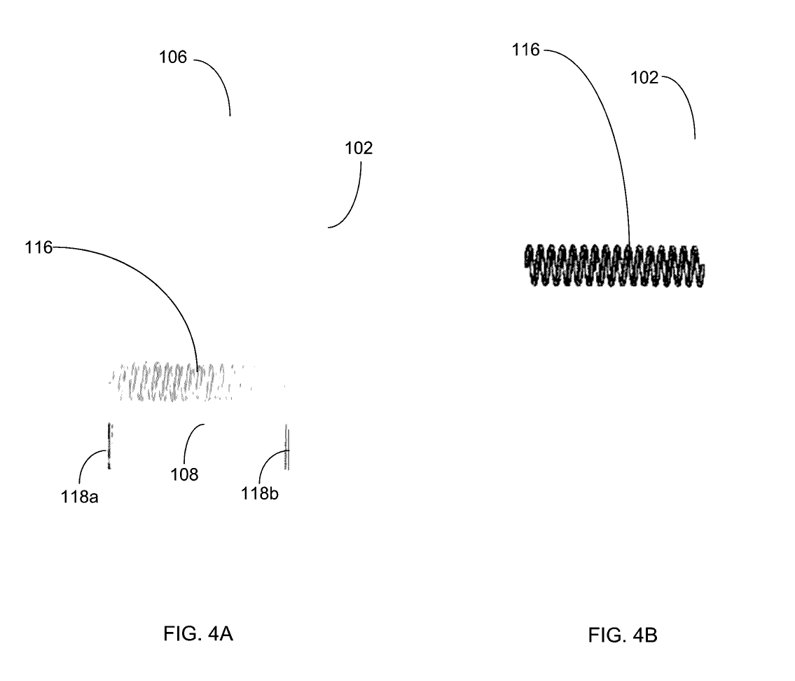

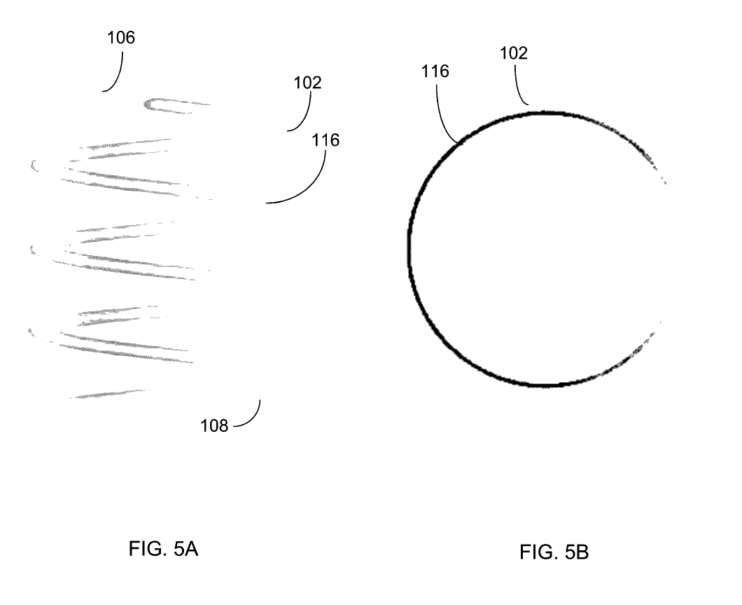

Turning now to FIGS. 4A and 4B, the heating coil 114 positions in a generally transverse orientation in relation to the length of the housing 102. This transverse position inside the chamber 100 is condensed, and thus heats up the coil body 116 rapidly. In another embodiment, shown in FIGS. 5A and 5B, the coil body 116 extends along the longitudinal axis of the chamber 100. This orientation covers the most volume area inside of the chamber 100, consequently creating an efficient atomization of the tobacco substance.

In some embodiments, the pair of free ends 118a, 118b from the heating coil 114 pass through the pair of outer holes 112a, 112b in the closed end 108 of the housing 102. The pair of free ends 118a, 118b engage a battery 122 and create a voltage therebetween. The battery 122 may include a general lithium-ion battery 122 known in the art. In one embodiment, resistive heating occurs as resistance in the heating coil 114 or circuitry produces the thermal energy for atomization. In any case, the nonporous material and the multiple dispositions of the heating coil 114 create an optimal atomization of a tobacco substance with minimal toxic cumulates that are known to cause off gas, aftertaste, detraction from the pure flavor of the tobacco substance being smoked at the time, and discoloration in the housing 102.

While the inventor's above description contains many specificities, these should not be construed as limitations on the scope, but rather as an exemplification of several preferred embodiments thereof. Many other variations are possible. For example, multiple heating coils 114 could be used in a spaced-apart relationship inside the housing 102. Accordingly, the scope should be determined not by the embodiments illustrated, but by the appended claims and their legal equivalents.

What is claimed is:

1. A nonporous atomizer chamber for optimal atomization of a tobacco substance, the chamber comprising:
a housing, the housing defined by a nonporous material, a sidewall, an open end, and a closed end, the closed end having a center hole and a pair of outer holes; and
a heating coil, the heating coil defined by a coil body and a pair of free ends, the coil body disposed in a generally coplanar orientation in relation to the closed end of the housing, the coil body configured to emit thermal energy in the housing, the pair of free ends arranged to pass through the pair of outer holes in the closed end of the housing, wherein the generally coplanar disposition of the coil body serves as a barrier to prevent blockage of the central hole and the pair of outer holes in the closed end of the housing.

2. The chamber of claim 1, wherein the housing has a substantially tubular shape.

3. The chamber of claim 1, wherein the nonporous material includes at least one member selected from the group consisting of: quartz, fused quarts, quartz-glass, and glass.

4. The chamber of claim 1, wherein the chamber is operable with a vaporizer, the vaporizer having a battery, a power switch, a tobacco substance chamber, a filter, and a mouthpiece.

5. The chamber of claim 4, wherein the chamber positions between the battery and the tobacco substance chamber.

6. The chamber of claim 5, wherein the chamber atomizes a tobacco substance.

7. The chamber of claim 6, further including a heat displacement coating on the sidewall of the housing.

8. The chamber of claim 7, wherein the center hole enables passage of outside air into the housing.

9. The chamber of claim 8, wherein the pair of outer holes enable passage of the pair of free ends from the heating coil for engaging the battery.

10. A nonporous atomizer chamber for optimal atomization of a tobacco substance, the chamber comprising:
a housing, the housing defined by a nonporous material, a sidewall, an open end, and a closed end, the closed end having a center hole and a pair of outer holes; and
a heating coil, the heating coil defined by a coil body and a pair of free ends, the coil body disposed in a generally transverse orientation in relation to the length of the housing, the coil body configured to emit thermal energy in the housing, the pair of free ends arranged to pass through the pair of outer holes in the closed end of the housing, wherein the generally transverse disposition of the coil body enables efficient heating in the housing.

11. The chamber of claim 10, wherein the housing has a substantially tubular shape.

12. The chamber of claim 10, wherein the nonporous material includes at least one member selected from the group consisting of: quartz, fused quarts, quartz-glass, and glass.

13. The chamber of claim 10, further including a heat displacement coating on the sidewall of the housing.

14. The chamber of claim 10, wherein the chamber is operable with a vaporizer, the vaporizer having a battery, a power switch, a tobacco substance chamber, a filter, and a mouthpiece.

15. The chamber of claim 10, wherein the center hole enables passage of outside air into the housing.

16. A nonporous atomizer chamber for optimal atomization of a tobacco substance, the chamber comprising:
a housing, the housing defined by a nonporous material, a sidewall, an open end, and a closed end, the sidewall having a heat displacement coating, the closed end having a center hole and a pair of outer holes; and
a heating coil, the heating coil defined by a coil body and a pair of free ends, the coil body configured to emit thermal energy in the chamber, the pair of free ends arranged to pass through the pair of outer holes in the closed end of the housing.

17. The chamber of claim 16, wherein the nonporous material includes at least one member selected from the group consisting of: quartz, fused quarts, quartz-glass, and glass.

18. The chamber of claim 16, wherein the coil body is disposed in a generally coplanar orientation in relation to the closed end of the housing, wherein the generally coplanar disposition of the coil body serves as a barrier to prevent blockage of the central hole and the pair of outer holes in the closed end of the housing.

19. The chamber of claim 16, wherein the coil body is disposed in a generally transverse orientation in relation to the length of the housing, wherein the generally transverse disposition of the coil body enables efficient heating in the housing.

20. The chamber of claim 16, wherein the coil body is disposed to extend along the length of the housing, wherein the generally axial disposition of the coil body occupies a substantial volume inside the housing.
